(19) United States
(12) Patent Application Publication
(10) Pub. No.: US 2026/0184521 A1
(43) Pub. Date: Jul. 2, 2026

(54) POCKET STAGE AND PUSHER PLATE SYSTEM AND METHOD

(71) Applicant: Cardtronics USA, Inc., Atlanta, GA (US)

(72) Inventors: Scott Low Colston, Dundee (GB); Matthew Bowen, Perth (GB); Zelin Liu, Monifieth (GB); Callum Jacklin, Dundee (GB); Jamie Kenneth Stewart, Dundee (GB)

(21) Appl. No.: 19/006,333

(22) Filed: Dec. 31, 2024

(51) Int. Cl. B65H 3/06; G07D 11/165

(52) U.S. Cl. CPC B65H 3/0684; B65H 3/063; B65H 3/0638; B65H 3/0653; G07D 11/165; B65H 2403/20; B65H 2404/531; B65H 2701/1912; G07D 2211/00

(57) ABSTRACT

An automated teller machine and associated methods are disclosed. A device may include a pocket to receive bank notes. A device may include a stage plate, wherein the stage plate is moveable up and down within the pocket in a range of motion. A device may include a number of rollers configured to engage one or more bank notes by passing through the stage plate when the stage plate is at a picking location within the range of motion, the number of rollers coupled to two different roller axles. A device may include a belt drive coupled between the two roller axles wherein the belt drive engages the two roller axles at a first roller axle diameter and a second roller axle diameter.

### TECHNICAL FIELD

Embodiments described herein generally relate to automatic teller machines and associated methods. Specific embodiments described herein relate to recycling automatic teller machines and configurations related to a slot for receiving bank notes.

### BACKGROUND

Automated Teller Machines (ATMs) have become an integral component of modern banking, enabling customers to perform a variety of transactions, including cash withdrawals, deposits, and balance inquiries. Despite their widespread use, traditional ATMs are typically limited in their ability to manage cash flow efficiently, particularly with respect to the handling, sorting, and redistribution of deposited currency. This inefficiency often leads to increased operational costs for financial institutions, including the need for frequent cash replenishment and manual cash handling by service personnel.

In response to these challenges, Automated Teller Machines that include a cash recycler have emerged as an innovative solution. ATMs integrate cash recycling capabilities into the traditional ATM framework. Recyclers are equipped with advanced mechanisms for verifying, sorting, and securely storing deposited banknotes. These stored banknotes can subsequently be reused for withdrawal transactions, effectively creating a closed-loop cash management system. This functionality reduces the frequency of cash replenishment, optimizes cash availability, and lowers the overall cost of operation.

Despite their advantages, the implementation of recyclers poses several challenges. For instance, ensuring the accurate authentication of deposited currency is needed to prevent the circulation of counterfeit banknotes. One technical challenge includes reliable mechanisms to pick bank notes from a stack, and to transport picked bank notes within a recycler of an ATM. Devices and methods are described in the present disclosure that address these concerns, and other technical challenges.

### BRIEF DESCRIPTION OF THE DRAWINGS

FIG. 1 shows a schematic of an automatic teller machine in accordance with some example embodiments.

FIG. 2A shows a block diagram of a pocket of an automatic teller machine in accordance with some example embodiments.

FIG. 2B shows another block diagram of a pocket of an automatic teller machine in accordance with some example embodiments.

FIG. 3 shows an isometric view of rollers of an automatic teller machine in accordance with some example embodiments.

FIG. 4A shows an isometric view of a stage plate of an automatic teller machine in accordance with some example embodiments.

FIG. 4B shows a top view of a roller in a slot of an automatic teller machine in accordance with some example embodiments.

FIG. 4C shows another top view of a roller in a slot of an automatic teller machine in accordance with some example embodiments.

FIG. 5 shows an isometric view of a pusher plate of an automatic teller machine in accordance with some example embodiments.

FIG. 6 shows a flow diagram of a method in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

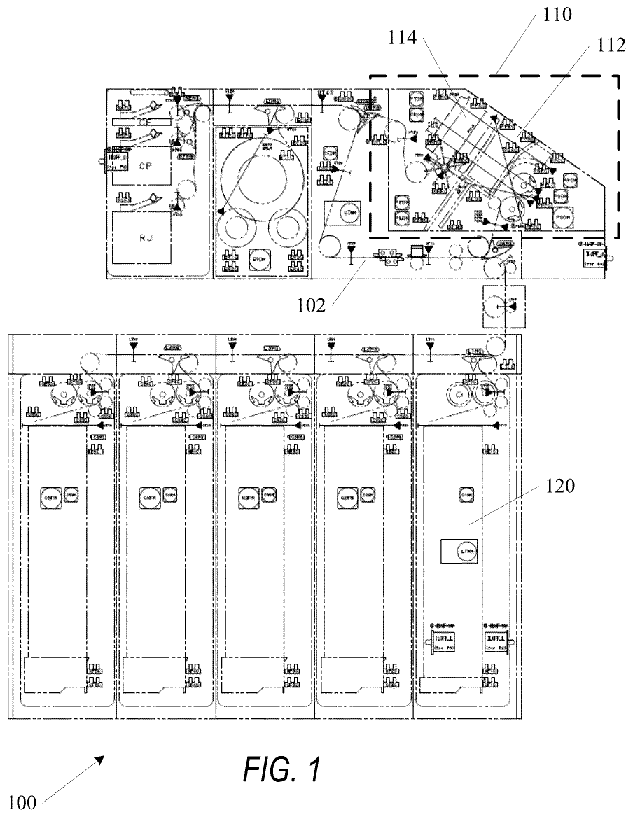

FIG. 1 shows an automatic teller machine 100 according to one example. The automatic teller machine 100 includes a pocket assembly 110. In the example of FIG. 1, the pocket assembly 110 is divided into a bottom compartment 112 and a top compartment 114. The pocket assembly 110 serves as the primary area for receiving and processing bank notes within the automatic teller machine 100. The bottom compartment 112 and the top compartment 114 are designed to facilitate the movement and storage of bank notes during various stages of a transaction process.

One or more note storage compartments 120 are shown. A belt 102 or other transport system is coupled between various components in the pocket assembly 110 and the note storage compartments 120. The note storage compartments 120 are connected to the pocket assembly 110 and provide a secure location for storing bank notes after they have been processed. The note storage compartment 120 ensures that bank notes are kept in an organized manner, ready for future transactions or for collection by authorized personnel. The connection between the pocket assembly 110 and the note storage compartment 120 allows for efficient transfer and storage of bank notes within the automatic teller machine 100.

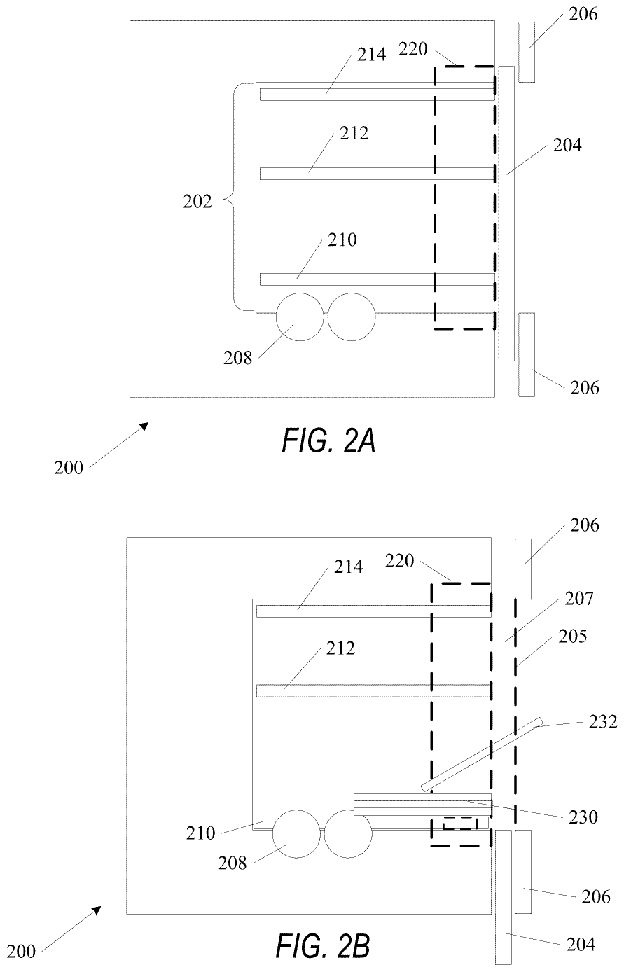

FIGS. 2A and 2B show a pocket assembly 200 similar to the pocket assembly 110 from FIG. 1. In FIG. 2A, a shutter 204 is shown in a closed position, covering a pocket 202. The pocket assembly 200 includes a pocket 202, which serves as the primary area for receiving bank notes. The fascia 206 is located on an exterior surface of the automatic teller machine, surrounding the pocket 202 and providing an interface for users. In the examples of FIGS. 2A and 2B, within the pocket 202, a stage plate 210 is shown, which is moveable up and down to facilitate the handling of bank notes.

Above the stage plate 210, a pusher plate 212 is located, which is also moveable up and down within the pocket 202 to press bank notes against the stage plate 210. A top plate 214 is positioned above the pusher plate 212. In one example, the top plate 214 is also moveable up and down within the pocket 202. On the side of the pocket 202, a side guide 220 is present, which aids in aligning bank notes within the pocket 202.

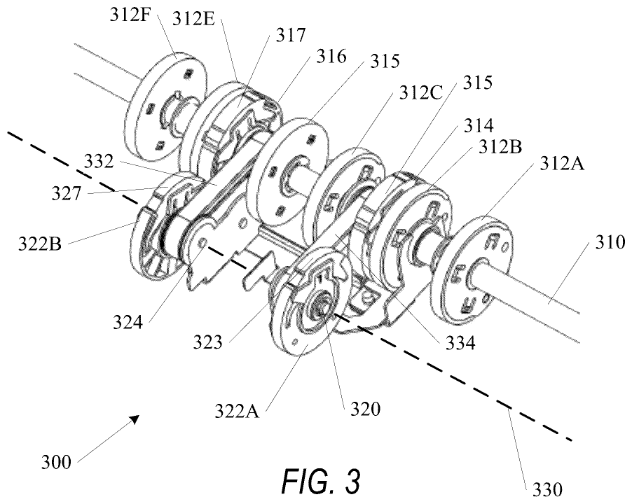

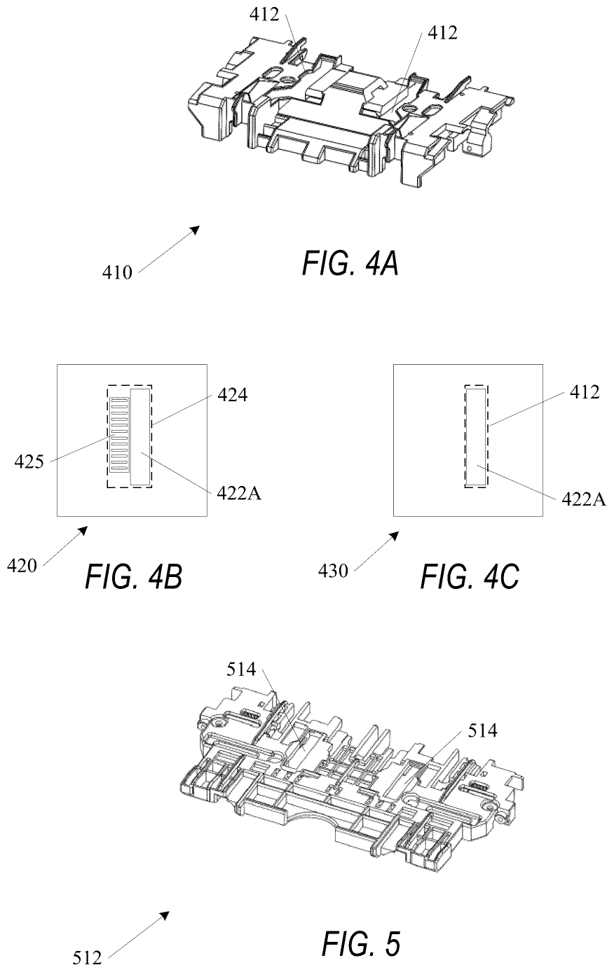

In the position shown in FIG. 2A, the stage plate 210 and a pusher plate 212 define a bottom compartment, similar to the bottom compartment 112 from FIG. 1. In operation, a stack of bank notes 230 is inserted onto the stage plate 210 and the stage plate 210 is lowered as shown in FIG. 2B. One or more rollers 208 protrude through the stage plate 210 in FIG. 2B and are used to transport individual notes 232 within the automatic teller machine. In one example, the pusher plate 212 is also lowered to apply pressure to the stack of bank notes 230 while the rollers 208 engage the stack, although not shown in FIG. 2B. Additional examples of rollers, similar to rollers 208 are shown below in FIG. 3. Additional examples of a stage plate and a pusher plate are shown below in FIGS. 4A-5.

A slot 207 is included to guide the shutter 204 between an extended position (shown in FIG. 2A) and a retracted position (shown in FIG. 2B). An edge of the slot 207 is shown by dashed line 205, and the slot 207 is located between the pocket 202 and the fascia 206 of the automatic teller machine.

FIG. 3 shows a number of rollers configured to engage one or more bank notes. The number of rollers are shown couples to at least two axles. FIG. 3 shows a first axle 310 that serves as a common axle for multiple rollers. Rollers 312A-F are included on first axle 310. Partially rubberized rollers 314 and 316 are also shown on first axle 310. In one example, a rubber insert (or other high friction polymer) is included as part of a perimeter of a roller to add friction. Partially rubberized rollers 314, 316 are used to pick bank notes and move them by a distance that is equal to an arc length of contact surface of the rubberized portions. Roller 314 includes rubberized portion 315, and roller 316 includes rubberized portion 317.

A common axis of rotation 330 is further shown in FIG. 3. The common axis of rotation 330 is spaced laterally and parallel to the first axle 310. A second roller 322A is shown on a second roller axle 320. The second roller axle 320 is colinear with the common axis of rotation 330. A belt drive 334 is shown coupled between the first axle 310 and the second roller axle 320. In the example of FIG. 3, the belt drive 334 engages the two roller axles (310, 320) at a first roller axle diameter and a second roller axle diameter. In selected examples, an engagement surface for the belt drive 334 is slightly larger than an outer diameter of the two roller axles (310, 320). In one example, the engagement surface for the belt drive 334 is substantially the same for both of the two roller axles (310, 320), although the invention is not so limited. Different engagement surface diameters can be used in other examples.

In operation, it is desirable to drive the second roller axle 320 using the belt drive 334 driven from the first axle 310 for a number of advantages. One advantage includes the low profile height of the belt drive 334. In configurations where rollers protrude through roller slots in a plate such as a stage plate or a pusher plate it is desirable to minimize or reduce a size of the roller slot. Larger openings may increase a likelihood of bank notes or foreign objects getting caught or jammed in the roller slots. Using a belt drive 334 allows a smaller roller slot to be used, because the belt drive 334 extends only a small distance above an outer diameter of the axles (310, 320).

The example of FIG. 3 further shows multiple second rollers 322A, 322B along the common axis of rotation 330. Second roller 322B is shown on a third roller axle 324. The third roller axle 324 is colinear with the common axis of rotation 330. A second belt drive 332 is shown coupled between the first axle 310 and the third roller axle 324. In the example of FIG. 3, the second belt drive 332 engages the two roller axles (310, 324) at a first roller axle diameter and a third roller axle diameter. Although separate axles 320, 324 are shown with the multiple second rollers 322A, 322B, the invention is not so limited. Other examples includes second rollers 322A, 322B on a single axle.

Similar to rollers 314 and 316, in one example, a rubber insert (or other high friction polymer) is included as part of a perimeter of other rollers to add friction. Partially rubberized rollers 322A and 322B are used to pick bank notes and move them by a distance that is equal to an arc length of contact surface of the rubberized portions. Roller 322A includes rubberized portion 323, and roller 322B includes rubberized portion 327.

FIG. 4A shows a stage plate 410 similar to stage plate 210 from FIGS. 2A and 2B. Stage plate 410 includes roller slots 412 that allow selected rollers as shown in FIG. 3 to pass through the stage plate 410 when the stage plate is at a picking location within a range of motion in a pocket such as pocket 202 from FIGS. 2A and 2B. FIG. 2B shows rollers 208 passing through the stage plate 210 using slots such as roller slot 412.

FIG. 4B shows a top view of a slot in an alternative configuration to a belt drive. In FIG. 4B, a roller 422A is shown, the roller 422A similar to roller 322A from FIG. 3. In the example of FIG. 4B, a gear 425 is shown adjacent to the roller 422A. Without a belt drive, a gear 425 of relatively large diameter is needed to drive roller 422A. As such a roller slot 424 to allow roller 422A to protrude through a stage plate is large enough to accommodate the gear 425 and the roller 422A. In some examples when a gear 425 is used, a shutter is employed to cover the larger roller slot 424 when the roller 422A is not protruding through the stage plate. Shutters include more complex hinges, and springs, etc. and increase a likelihood of components of a shutter failing or becoming damaged. It is desirable to remove such roller slot shutters entirely to improve reliability of the automated teller machine in general.

FIG. 4C shows the roller 422A when a belt drive as shown in FIG. 3 is employed. No gears 425 are used, and as a result a size of a roller slot 412 is much smaller. As noted above, minimal roller slot sizes are desirable to reduce a potential for items such as bank notes or other objects to become snagged on the roller slot. In one example, using roller slots 412 that are sized to only accommodate roller 422A, and not sized to accommodate a gear 425, the roller slots 412 do not need any shutters to cover the roller slots 412 when rollers 422A are not protruding through them. This reduces machine complexity and improves reliability.

FIG. 5 shows a pusher plate 512 similar to pusher plate 212 from FIGS. 2A and 2B. Pusher plate 512 includes roller slots 514 that allow selected rollers as shown in FIG. 3 to pass through the pusher plate 512 when the pusher plate is at a picking location within a range of motion in a pocket such as pocket 202 from FIGS. 2A and 2B. Using FIGS. 2A and 2B as an example in one operation, the stage plate 410 and the pusher plate 512 are both lowered such that rollers 208 pass through both the stage plate 210 and the pusher plate 212. The top plate 214 may be lowered to put pressure on bank notes that are on top of the pusher plate (the top compartment 114 as shown in FIG. 1).

Similar to the description of roller slots 412 in FIG. 4A, in FIG. 5, roller slots 514 are sized to only accommodate a roller, and not sized to accommodate a gear, the roller slots 514 do not need any shutters to cover the roller slots 514 when rollers are not protruding through them. This reduces machine complexity and improves reliability. Rollers can be configured to pass through the stage plate 410 and the pusher plate 512 in respective roller slots (412, 514) dimensioned to fit closely around an exposed portion of each roller, as shown in FIG. 4C.

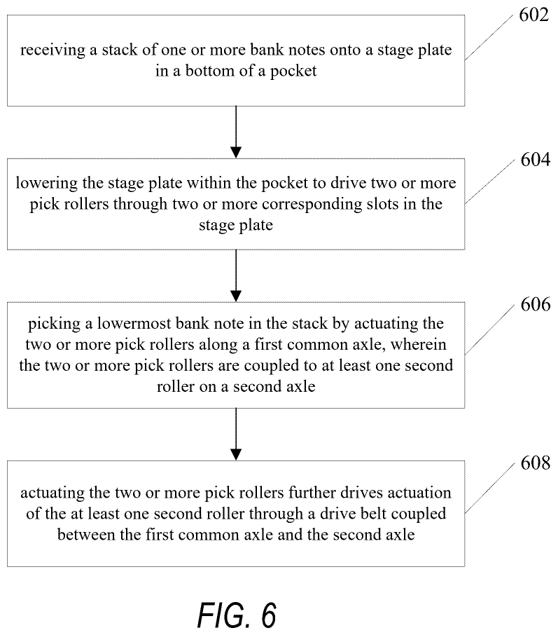

FIG. 6 shows a flow diagram of an example method of operation. In operation 602 a stack of one or more bank notes are received onto a stage plate in a bottom of a pocket. In operation 604, the stage plate is lowered within the pocket to drive two or more pick rollers through two or more corresponding slots in the stage plate. In operation 606, a lowermost bank note in the stack is picked by actuating the two or more pick rollers along a first common axle, wherein the two or more pick rollers are coupled to at least one second roller on a second axle. In operation 608, it is further described that actuating the two or more pick rollers further drives actuation of the at least one second roller through a drive belt coupled between the first common axle and the second axle.

To better illustrate the method and apparatuses disclosed herein, a non-limiting list of embodiments is provided here:

Example 1. An automatic teller machine, comprising: a pocket to receive bank notes; a stage plate, wherein the stage plate is moveable up and down within the pocket in a range of motion; a number of rollers configured to engage one or more bank notes by passing through the stage plate when the stage plate is at a picking location within the range of motion, the number of rollers coupled to two different roller axles; and a belt drive coupled between the two roller axles wherein the belt drive engages the two roller axles at a first roller axle diameter and a second roller axle diameter.

Example 2. The automatic teller machine of example 1, wherein the first roller axle diameter is the same as the second roller axle diameter.

Example 3. The automatic teller machine of example 1, wherein there are no gears coupled between the two different roller axles.

Example 4. The automatic teller machine of example 1, wherein a first roller axle of the two different roller axles includes eight rollers.

Example 5. The automatic teller machine of example 4, wherein a second roller axle of the two different roller axles includes multiple second rollers along a common axis.

Example 6. The automatic teller machine of example 5, wherein the multiple second rollers are driven by multiple drive belts.

Example 7. The automatic teller machine of example 4, wherein two of the eight rollers are partially rubberized.

Example 8. An automatic teller machine, comprising: a pocket to receive bank notes; a stage plate, wherein the stage plate is moveable up and down within the pocket in a range of motion; a pusher plate, wherein the pusher plate is moveable up and down within the pocket in the range of motion; a number of rollers configured to engage one or more bank notes by passing through the stage plate and the pusher plate when the stage plate and the pusher plate are at a picking location within the range of motion, the number of rollers coupled to two different roller axles; and a belt drive coupled between the two different roller axles wherein the belt drive engages the two different roller axles at a first roller axle diameter and a second roller axle diameter.

Example 9. The automatic teller machine of example 8, wherein the first roller axle diameter is the same as the second roller axle diameter.

Example 10. The automatic teller machine of example 8, wherein there are no gears coupled between the two different roller axles.

Example 11. The automatic teller machine of example 8, wherein a first roller axle of the two different roller axles includes eight rollers.

Example 12. The automatic teller machine of example 8, wherein each roller in the number of rollers is configured to pass through the stage plate and the pusher plate in a respective roller slot dimensioned to fit closely around an exposed portion of each roller.

Example 13. The automatic teller machine of example 8, wherein the belt drive is one of multiple drive belts between a first common axle of the two different roller axles and multiple second axles.

Example 14. A method of receiving bank notes in an automatic teller machine, comprising: receiving a stack of one or more bank notes onto a stage plate in a bottom of a pocket; lowering the stage plate within the pocket to drive two or more pick rollers through two or more corresponding slots in the stage plate; picking a lowermost bank note in the stack by actuating the two or more pick rollers along a first common axle, wherein the two or more pick rollers are coupled to at least one second roller on a second axle; and wherein actuating the two or more pick rollers further drives actuation of the at least one second roller through a drive belt coupled between the first common axle and the second axle.

Example 15. The method of example 14, wherein actuating the two or more pick rollers to further drive actuation of the at least one second roller includes driving at substantially a same radial speed as a result of similar belt drive diameters.

Example 16. The method of example 15, wherein driving at substantially a same radial speed as a result of similar belt drive diameters includes driving the drive belt over two axles with a same axle diameter in each of the two axles.

Example 17. The method of example 14, wherein lowering the stage plate to drive two or more pick rollers through two or more corresponding slots in the stage plate includes lowering without opening any shutters to expose the two or more corresponding slots.

Example 18. The method of example 14, wherein actuating the two or more pick rollers further drives actuation of the at least one second roller through the drive belt includes actuation of the at least one second roller through a flat drive belt.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An automatic teller machine, comprising:
a pocket to receive bank notes;
a stage plate, wherein the stage plate is moveable up and down within the pocket in a range of motion;
a number of rollers configured to engage one or more bank notes by passing through the stage plate when the stage plate is at a picking location within the range of motion, the number of rollers coupled to two different roller axles; and
a belt drive coupled between the two roller axles wherein the belt drive engages the two roller axles at a location laterally offset between rollers in the number of rollers at a first roller axle diameter and a second roller axle diameter.

2. The automatic teller machine of claim 1, wherein the first roller axle diameter is the same as the second roller axle diameter.

3. The automatic teller machine of claim 1, wherein there are no gears coupled between the two different roller axles.

4. The automatic teller machine of claim 1, wherein a first roller axle of the two different roller axles includes eight rollers.

5. The automatic teller machine of claim 4, wherein a second roller axle of the two different roller axles includes multiple second rollers along a common axis.

6. The automatic teller machine of claim 5, wherein the multiple second rollers are driven by multiple drive belts.

7. The automatic teller machine of claim 4, wherein two of the eight rollers are partially rubberized.

8. An automatic teller machine, comprising:
a pocket to receive bank notes;
a stage plate, wherein the stage plate is moveable up and down within the pocket in a range of motion;
a pusher plate, wherein the pusher plate is moveable up and down within the pocket in the range of motion;
a number of rollers configured to engage one or more bank notes by passing through the stage plate and the pusher plate when the stage plate and the pusher plate are at a picking location within the range of motion, the number of rollers coupled to two different roller axles; and
a belt drive coupled between the two different roller axles wherein the belt drive engages the two different roller axles at a location laterally offset between rollers in the number of rollers at a first roller axle diameter and a second roller axle diameter.

9. The automatic teller machine of claim 8, wherein the first roller axle diameter is the same as the second roller axle diameter.

10. The automatic teller machine of claim 8, wherein there are no gears coupled between the two different roller axles.

11. The automatic teller machine of claim 8, wherein a first roller axle of the two different roller axles includes eight rollers.

12. The automatic teller machine of claim 8, wherein each roller in the number of rollers is configured to pass through the stage plate and the pusher plate in a respective roller slot dimensioned to fit closely around an exposed portion of each roller.

13. The automatic teller machine of claim 8, wherein the belt drive is one of multiple drive belts between a first common axle of the two different roller axles and multiple second axles.

14. A method of receiving bank notes in an automatic teller machine, comprising:
receiving a stack of one or more bank notes onto a stage plate in a bottom of a pocket;
lowering the stage plate within the pocket to drive two or more pick rollers through two or more corresponding slots in the stage plate;
picking a lowermost bank note in the stack by actuating the two or more pick rollers along a first common axle, wherein the two or more pick rollers are coupled to at least one second roller on a second axle; and
wherein actuating the two or more pick rollers further drives actuation of the at least one second roller through a drive belt located laterally offset from the two or more pick rollers and the at least one second roller, the drive belt coupled between the first common axle and the second axle.

15. The method of claim 14, wherein actuating the two or more pick rollers to further drive actuation of the at least one second roller includes driving at substantially a same radial speed as a result of similar belt drive diameters.

16. The method of claim 15, wherein driving at substantially a same radial speed as a result of similar belt drive diameters includes driving the drive belt over two axles with a same axle diameter in each of the two axles.

17. The method of claim 14, wherein lowering the stage plate to drive two or more pick rollers through two or more corresponding slots in the stage plate includes lowering without opening any shutters to expose the two or more corresponding slots.

18. The method of claim 14, wherein actuating the two or more pick rollers further drives actuation of the at least one second roller through the drive belt includes actuation of the at least one second roller through a flat drive belt.
